(19) United States
(12) Patent Application Publication
(10) Pub. No.: US 2006/0218798 A1
(43) Pub. Date: Oct. 5, 2006

(54) Knife holder

(76) Inventor: Gary Chen, Taichung City (TW)

Correspondence Address: Keith Kline;PRO-TECHTOR INTERNATIONAL, 20775 Norada Court, Saratoga, CA, 95070-3018, US

(21) Appl. No.: 11/095,642

(22) Filed: Mar. 30, 2005

(51) Int. Cl. B26B 27/00

(52) U.S. Cl. 30/298

(57) ABSTRACT

Provided is a knife holder comprising a flexible open containing member of substantially parallelepiped, the containing member comprising four bent corners; and a rectangular flexible member received in the containing member, the flexible member comprising folds substantially disposed in parallel with width of the containing member. The fold comprises two force exertion faces. Two opposite force exertion faces of two adjacent folds are adapted to clamp a blade of an inserted knife and the force exertion faces are clamped by the corners if the width of the knife is equal to or slightly smaller than the width of the containing member. In another embodiment, the flexible member further comprises projections or through holes formed on both surfaces thereof.

### BACKGROUND OF THE INVENTION

1. Field of Invention

The present invention relates to holders and more particularly to a knife holder with improved characteristics.

2. Related Art

A conventional knife holder is implemented as an open container and has a number of slots of different sizes such that different knives can be inserted into corresponding slots for storage. However, it is impossible of inserting a knife into the holder if there is no appropriate slot for receiving the knife due to different sizes. Moreover, it is also impossible of inserting a knife into the holder if all available slots thereof are occupied (i.e., the number of slots is limited).

Another conventional knife holder is implemented as an elongate, hollow, rectangular plate member mounted on a wall of kitchen or cabinet. The holder is adapted to hold a plurality of knives. However, the second prior holder suffered from two disadvantages. For example, the blade of the knife is exposed, i.e., the hand of a user may be cut by the blade if sufficient care is not taken. Further, the knife may fall on the ground due to careless contact or vibration. This is not safe. Thus, the need for improvement still exists.

### SUMMARY OF THE INVENTION

It is therefore an object of the present invention to provide a knife holder comprising a flexible open containing member of substantially parallelepiped, the containing member comprising four bent corners; and a rectangular flexible member received in the containing member, the flexible member comprising a plurality of folds each substantially disposed in parallel with width of the containing member, the fold including two force exertion faces on its both surfaces; wherein either force exertion face of the fold has an adjustable length substantially equal to width of an inserted knife such that two opposite force exertion faces of two adjacent folds are adapted to clamp a blade of the knife and the force exertion faces are clamped by the corners if the width of the knife is equal to the width of the containing member or less than that by a small predetermined value.

In one aspect of the present invention, the flexible member further comprises a plurality of projections formed on both surfaces thereof.

In another aspect of the present invention, the flexible member further comprises a plurality of through holes formed on both surfaces thereof.

The above and other objects, features and advantages of the present invention will become apparent from the following detailed description taken with the accompanying drawings.

### BRIEF DESCRIPTION OF THE DRAWINGS

FIG. 1 is an exploded view of a preferred embodiment of knife holder according to the invention;

FIG. 2 is a perspective view of the assembled holder in its first configuration;

FIG. 3 is a top plan view of the holder in FIG. 2 where the holder has been resiliently compressed to shape as a second configuration thereof;

FIG. 4 is a longitudinal sectional view of FIG. 3;

FIG. 5 is a top plan view of the holder in its first configuration where two knives are held in place in a first arrangement;

FIG. 6 is a view similar to FIG. 5, where three knives are held in place in a second arrangement;

FIG. 7 is a longitudinal sectional view of FIG. 6;

FIG. 8 is a view similar to FIG. 2 where seven knives are held in place in a third arrangement;

FIG. 9 is a perspective view of the flexible member according to a first preferred embodiment thereof;

FIG. 10 is a top plan view of a knife sandwiched by two adjacent folds of the flexible member in FIG. 9;

FIG. 11 is a greatly enlarged view of the circle area in FIG. 9; and

FIG. 12 is a perspective view of the flexible member according to a second preferred embodiment thereof.

### DETAILED DESCRIPTION OF THE INVENTION

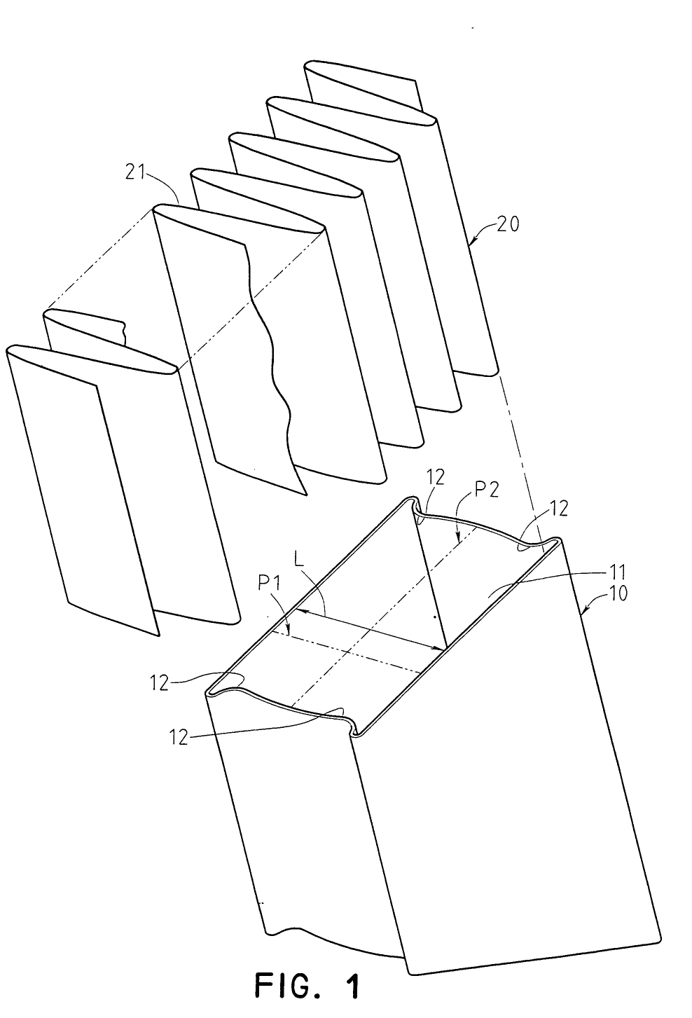

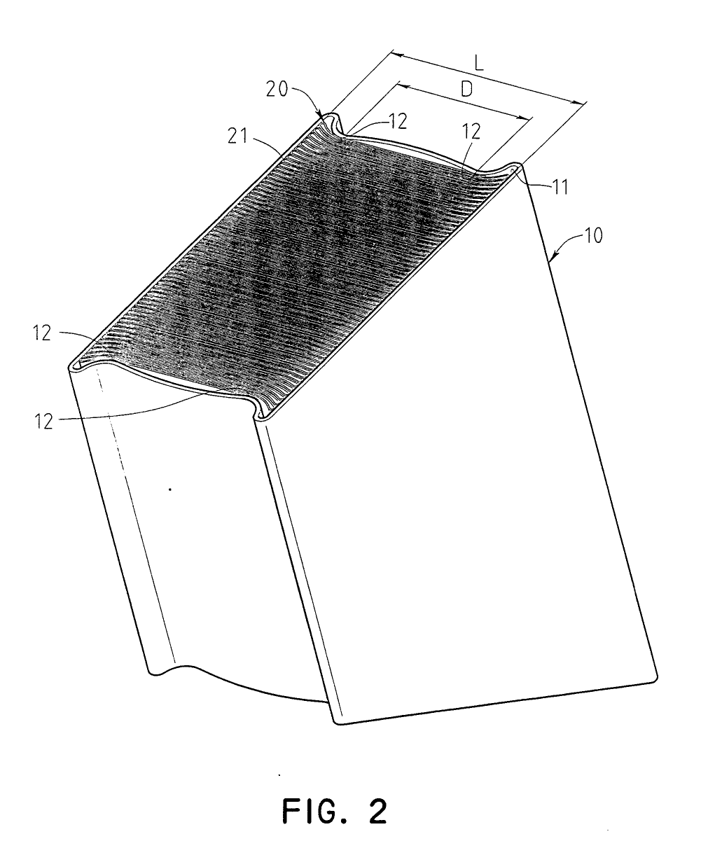

Referring to FIGS. 1 and 2, there is shown a knife holder constructed in accordance with a preferred embodiment of the invention. The holder comprises a flexible containing member 10 of substantially parallelepiped with a top opening. The containing member 10 comprises an internal space 11 having a first direction P1 along length L and a second direction P2 along width, i.e., directions P1 and P2 are perpendicular each other. Note that both width and length L of the containing member 10 are adjustable due to its flexible structure. The containing member 10 further comprises four bent corners 12.

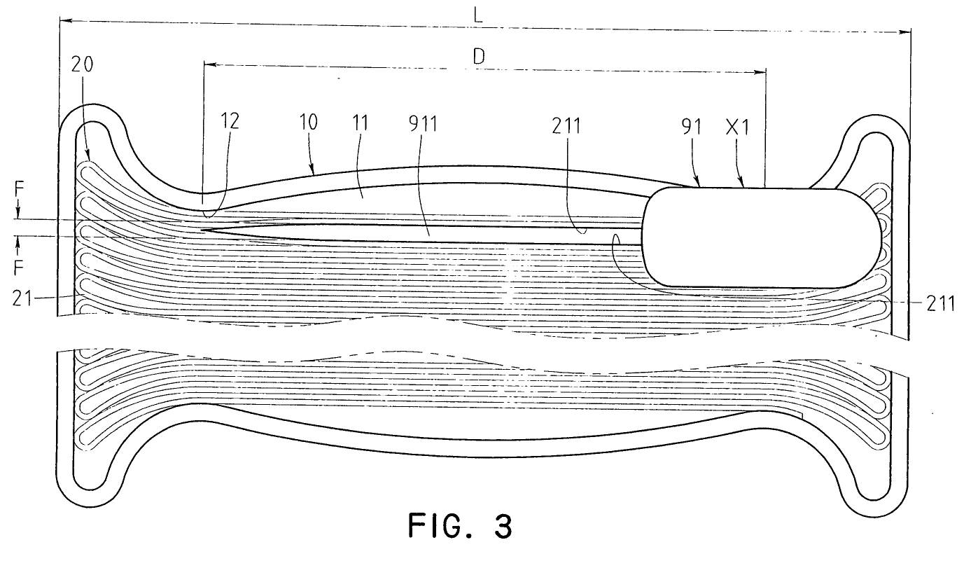

The holder further comprises a rectangular flexible member 20 received in the space 11. The flexible member 20 comprises a plurality of folds 21 each substantially disposed in parallel with the first direction P1. Referring to FIG. 3, the holder has been resiliently compressed to shape as a second configuration different from a first configuration shown in FIG. 2. The fold 21 comprises two force exertion faces 211 on its both surfaces, each force exertion face 211 having a length D substantially equal to width of the blade 911 of a knife (e.g., cleaver) 91. The blade 911 is clamped by two opposite force exertion faces 211 of two adjacent folds 21 in a first position X1. The force exertion faces 211 are further clamped by two pairs of opposing corners 12. As such, the blade 911 is fastened.

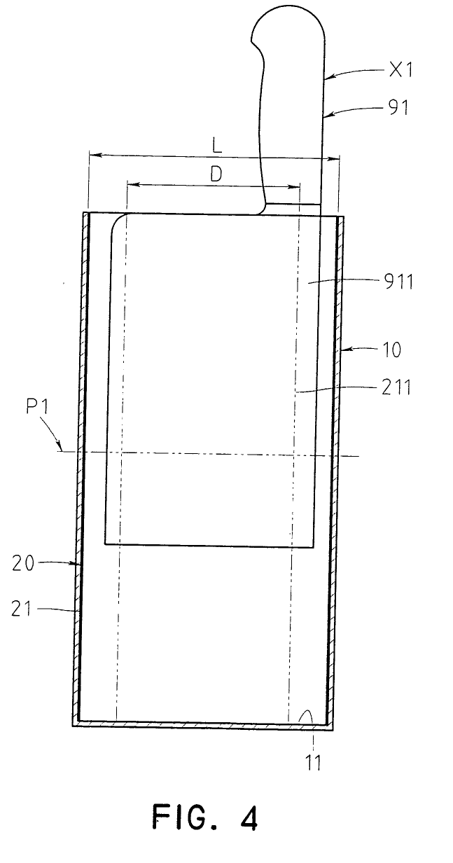

Referring to FIG. 4, the inserted cleaver 91 has a shorter blade 911. That is, a forward end of the blade 911 is disposed above bottom of the containing member 10. Advantageously, the fastening of the cleaver 91 is not adversely affected at all.

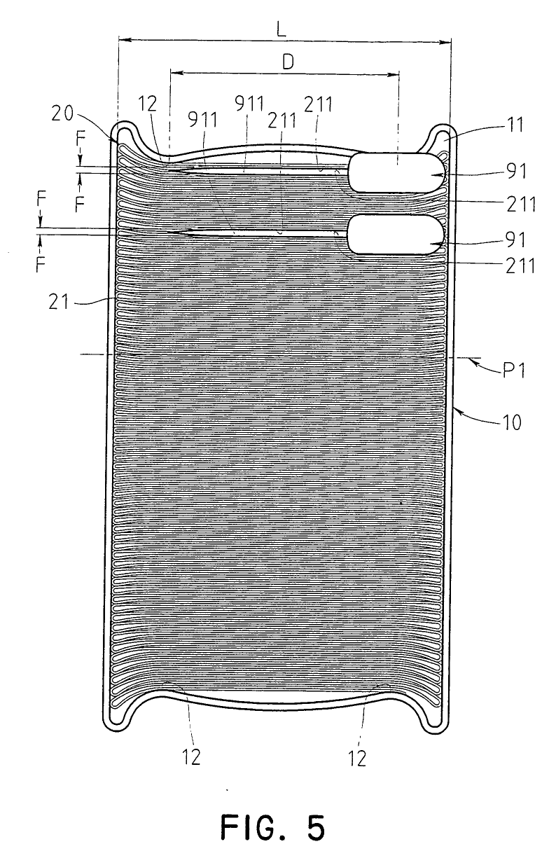

Referring to FIG. 5, two cleavers 91 are inserted into the containing member 10 in close proximity. A clamping force F is exerted on either surface of the blade 91 by the proximate force exertion face 211. Thus, the cleavers 91 are fastened.

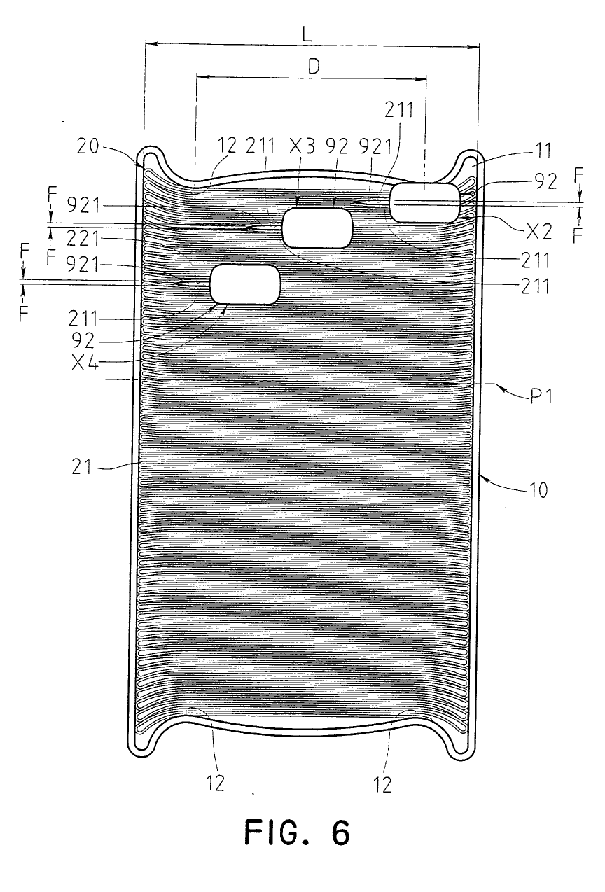

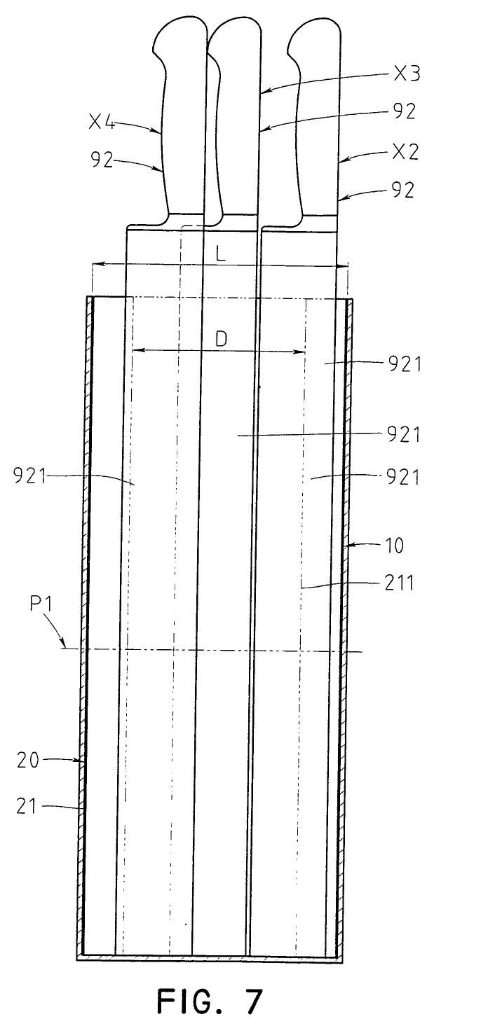

Referring to FIGS. 6 and 7, three carving knives 92 are inserted into the containing member 10 along the first direction P1. The blade 921 of each carving knife 92 is clamped by two opposite force exertion faces 211 of two adjacent folds 21 in a second, third, or fourth position X2, X3, or X4. Width of the blade 921 of each carving knife 92 is about one third of length L. As such, the carving knives 92 are fastened.

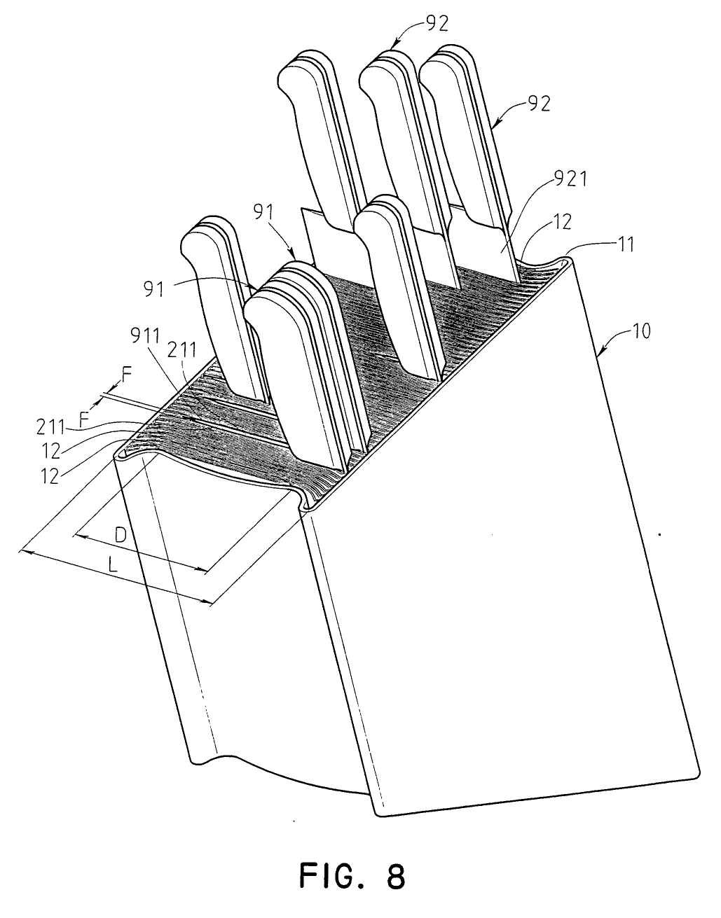

Referring to FIG. 8, a plurality of cleavers 91 and carving knives 92 are inserted into the holder 10. The clamping force F exerted on either surface of the blade 911 of the cleaver 91 or the blade 921 of the carving knife 92 is sufficient to hold the cleaver 91 or the carving knife 92 in place. This arrangement means to show that the holder is adapted to hold knives of different sizes in place.

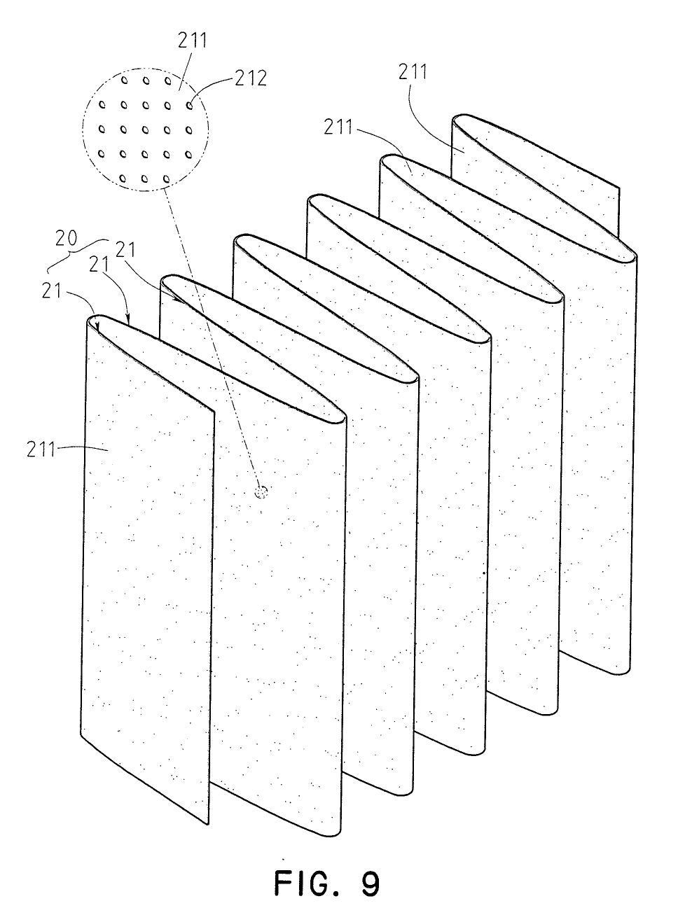

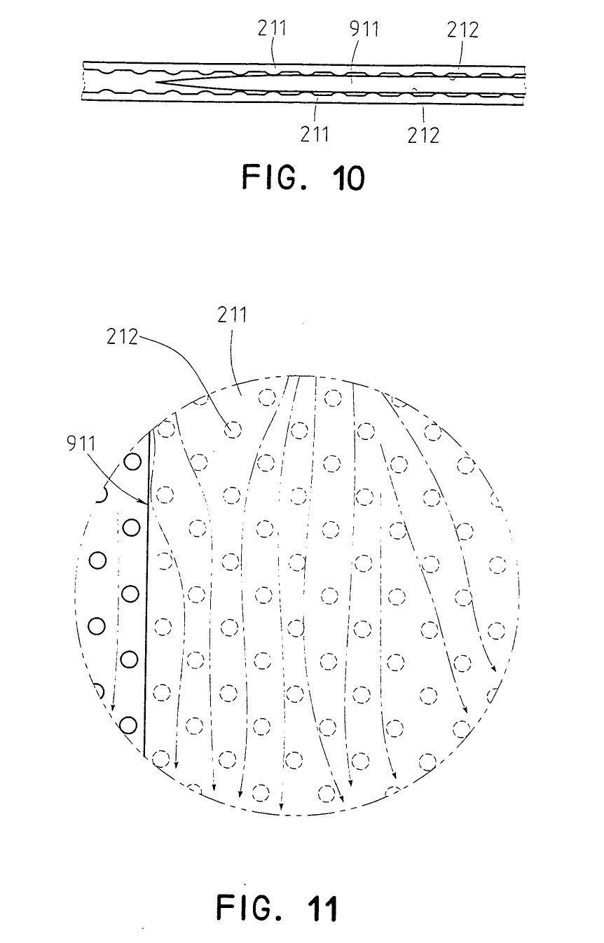

Referring to FIGS. 9, 10 and 11, both surfaces of the flexible member 20 are formed with a plurality of small projections 212 arranged in rows and columns according to a first preferred embodiment thereof. The provision of projections 212 aims at ventilation such that it is possible of preventing a cleaver 91 held between two opposite force exertion faces 211 of two adjacent folds 21 from being rusted.

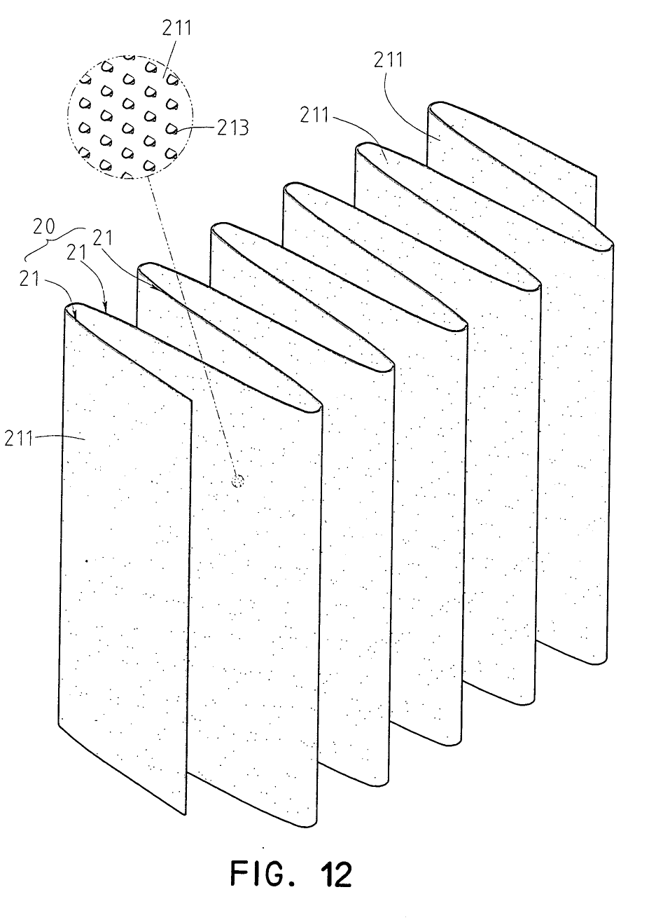

Referring to FIG. 12, in a second preferred embodiment of the flexible member 20 a plurality of small through holes 213 are formed on both surfaces thereof and are arranged in rows and columns. The provision of through holes 213 aims at ventilation such that it is also possible of preventing a cleaver 91 held between two opposite force exertion faces 211 of two adjacent folds 21 from being rusted.

While the invention herein disclosed has been described by means of specific embodiments, numerous modifications and variations could be made thereto by those skilled in the art without departing from the scope and spirit of the invention set forth in the claims.

What is claimed is:

1. A knife holder comprising:
a flexible open containing member of substantially parallelepiped, the containing member comprising four bent corners; and
a rectangular flexible member received in the containing member, the flexible member comprising a plurality of folds each substantially disposed in parallel with width of the containing member, the fold including two force exertion faces on its both surfaces;
wherein either force exertion face of the fold has an adjustable length substantially equal to width of an inserted knife such that two opposite force exertion faces of two adjacent folds are adapted to clamp a blade of the knife and the force exertion faces are clamped by the corners if the width of the knife is equal to the width of the containing member or less than that by a small predetermined value.

2. The knife holder of claim 1, wherein the flexible member further comprises a plurality of projections formed on both surfaces thereof.

3. The knife holder of claim 1, wherein the flexible member further comprises a plurality of through holes formed on both surfaces thereof.
